(19) United States
(12) Patent Application Publication
(10) Pub. No.: US 2009/0013241 A1
(43) Pub. Date: Jan. 8, 2009

(54) CONTENT REPRODUCING UNIT, CONTENT REPRODUCING METHOD AND COMPUTER-READABLE MEDIUM

(76) Inventor: Tomomi KAMINAGA, Tokyo (JP)

Correspondence Address: STRAUB & POKOTYLO, 788 Shrewsbury Avenue, Tinton Falls, NJ, 07724, US

(21) Appl. No.: 12/144,470

(22) Filed: Jun. 23, 2008

(30) Foreign Application Priority Data
Jul. 4, 2007 (JP) 2007-176411
Jul. 18, 2007 (JP) 2007-186981

(51) Int. Cl. G06F 17/00; G06F 7/06; G06F 15/16; G06F 17/30

(52) U.S. Cl. 715/203; 707/5; 709/219; 707/E17.01; 707/E17.017

(57) ABSTRACT

A reproducing unit, comprising: a time control section for controlling time in order to reproduce content having time and date information in an order according to that time and date information; a content search section for searching for content having time and date information corresponding to a time defined by the time control section from a plurality of categories of content; a storage section for storing a plurality of the searched contents of differing categories; a time image creation section for creating a time image, for representing time information representing a specified range of time, controlled by the time control section, by a specified length, and representing that content of time and data information corresponding to that time and date information exists, including content information arranged at a position of the time information corresponding to the time information; and a reproduction control unit for performing control so that the stored content of different categories is reproduced at a timing corresponding to the category of the content, on the basis of time controlled by the time control section.

Benefit is claimed, under 35 U.S.C. §119, to the filing date of prior Japanese Patent Application No. 2007-176411, filed on Jul. 4, 2007, and Japanese Patent Application No. 2007-186981, filed on Jul. 18, 2007. These applications are expressly incorporated herein by reference. The scope of the present invention is not limited to any requirements of the specific embodiments described in the applications.

### BACKGROUND OF THE INVENTION

1. Field of the Invention

The present invention relates to a reproducing unit, reproducing method and computer-readable medium for reproducing content of an image etc.

2. Description of the Related Art

In recent years, when viewing images that have been taken with a digital camera or the like, it has become possible to carry out viewing from a conventional photographic print using a reproducing unit such as widely used personal computer or the like. As image viewing using a reproducing unit, sequential reproduction is often carried out while switching images, as opposed to reproduction of a particular image, and in this situation a slideshow is widely used, in which still images are reproduced and changed at specified intervals (for example, 2 seconds) according to the order in which they were taken. This slideshow does not require any effort to switch the images, and is very convenient for enjoying looking at images while talking to friends or carrying out some other task.

Also, as a way of enjoying a slideshow, Japanese Unexamined Patent Application No. 2006-261933 (laid-open Sep. 28, 2006) discloses an image processing unit that displays taken images in the order in which they were taken. Specifically, in this image processing device, rapidly taken images are reproduced one after the other while being switched relatively quickly, while conversely images taken quite far apart in time are displayed for a comparatively long time on the screen.

Further, an environment has recently evolved in which it is possible to procure not only image data by means of the Internet, but also various content data such as music data, document data, etc. There has also been proposed an electronic device that, as well as being a reproducing unit, performs recording and reproduction of not only image data, but also multimedia such as music data (refer to Japanese Unexamined Patent Application No. 2005-51500 (laid-open Feb. 24, 2005)). With the electronic device disclosed in this patent document 2, a list of reproducible content is displayed superimposed on a screen during reproduction, and usability is improved.

Also, with conventional content, it is common practice to enjoy listening to music or viewing pictures on separate dedicated devices, but the present applicant has proposed a reproducing unit that enables a new way of enjoying a mix of images and music, in order to broaden the way in which multimedia is enjoyed (Japanese Unexamined Patent Application No. 2006-40134 (laid-open Feb. 9, 2006)). Further, as a method of effectively searching a large number of images relating to important images from among content, the present applicant has proposed an image display device for simplifying image search by arranging thumbnail images along a time display section formed from separate time circles for year/month/day (refer to Japanese unexamined patent application no. 2006-180466 (laid open Jul. 6, 2006)).

### SUMMARY OF THE INVENTION

The present invention has as an object to provide a reproduction unit, reproduction method and a computer-readable medium that can utilize content of different categories.

The present invention also has as its object to provide a reproducing unit, reproducing method and a program such that a user does not become bored, even when reproducing image data, which is biased towards rapidity with which they were taken, in a sequence that reproduces images according to time taken.

With respect to content having time and date information, the present invention searches for content having time and date information corresponding to that time and data information, and displays according to time information. A plurality of types of content are also searched.

Also, for content having time and date information, in a case where, when reproducing contents such as taken images in line with time and date information, content to be reproduced does not exist, the present invention creates an image corresponding to time and date information, such as a weather image, and displays this.

### BRIEF DESCRIPTION OF THE DRAWINGS

FIG. 1 is a block diagram showing the structure of a reproducing unit relating to a first embodiment of the present invention.

FIG. 2 is a clock image used with a reproducing unit relating to a first embodiment of the present invention.

FIG. 3 is a drawing showing display of multi-content of a display screen of a reproducing unit relating to a first embodiment of the present invention, and is a screen at the time of reproduction start.

FIG. 4 is a drawing showing display of multi-content of a display screen of a reproducing unit relating to a first embodiment of the present invention, and is a screen for April 8th, 6 o'clock am.

FIG. 5 is a drawing showing display of multi-content of a display screen of a reproducing unit relating to a first embodiment of the present invention, and is a screen for April 8th, 12 O'clock pm.

FIG. 6 is a drawing showing display of multi-content of a display screen of a reproducing unit relating to a first embodiment of the present invention, and is a screen for April 8th, 6 O'clock, pm.

FIG. 7 is a drawing showing display of multi-content of a display screen of a reproducing unit relating to a first embodiment of the present invention, and is a screen for April 8th 11 o'clock, pm.

FIG. 8 is a drawing showing a clock face on a display screen of a reproducing unit relating to a first embodiment of the present invention.

FIG. 9 is a drawing showing a modified example of display of multi-content of a display screen of a reproducing unit relating to a first embodiment of the present invention.

FIG. 10 is a drawing of display of multi-content of a display screen of a reproducing unit relating to a first embodiment of the present invention, and shows a reproduction state of a background image and content.

FIG. 11 is a flowchart showing main flow of a reproducing unit relating to a first embodiment of the present invention.

FIG. 12 is a flowchart showing a subroutine for content reproduction preparation of a reproducing unit relating to a first embodiment of the present invention.

FIG. 13 is a flowchart showing a subroutine for content reproduction execution of a reproducing unit relating to a first embodiment of the present invention.

FIG. 14 is a flowchart showing a subroutine for background information generation of a reproducing unit relating to a first embodiment of the present invention.

FIG. 15 is a flowchart showing a subroutine for time image generation of a reproducing unit relating to a first embodiment of the present invention.

FIG. 16 is a flowchart showing a subroutine for content creation of a reproducing unit relating to a first embodiment of the present invention.

FIG. 17 is a block diagram showing the structure of a reproducing unit relating to a second embodiment of the present invention.

FIG. 18 shows a display screen, in a display screen of a reproducing unit relating to the second embodiment of the present invention, in the case where an image (movie, still image) exists in an appropriate month.

FIG. 19 is a drawing showing display of multi-content of a display screen of a reproducing unit relating to a second embodiment of the present invention, and is a screen for April 8th, 12 O'clock pm.

FIG. 20 shows a display screen, in a display screen of a reproducing unit relating to the second embodiment of the present invention, in the case where an image (movie, still image) does not exist in an appropriate month.

FIG. 21 is a drawing showing weather information display for a display screen of a reproducing unit relating to a second embodiment of the present invention, and is a screen showing the case of snow.

FIG. 22 is a drawing showing weather information display for a display screen of a reproducing unit relating to a second embodiment of the present invention, and is a screen showing the case of rain.

FIG. 23 is a drawing showing weather information display for a display screen of a reproducing unit relating to a second embodiment of the present invention, and is a screen showing the case of thunder.

FIG. 24 is a drawing showing weather information display for a display screen of a reproducing unit relating to a second embodiment of the present invention, and is a screen showing the case of fine weather.

FIG. 25 is a flowchart showing main flow of a reproducing unit relating to a second embodiment of the present invention.

FIG. 26 is a flowchart showing a subroutine for content reproduction preparation of a reproducing unit relating to a second embodiment of the present invention.

FIG. 27 is a flowchart showing a subroutine for content reproduction execution of a reproducing unit relating to a second embodiment of the present invention.

### DETAILED DESCRIPTION OF THE PREFERRED EMBODIMENTS

In the following, preferred embodiments using a reproducing unit adopting the present invention will be described using the drawings. The reproducing unit of the embodiment of the invention is capable of connection to the Internet, and is capable of storing movies and still pictures, and is constructed using a personal computer having a reproducing function for these images and a reproducing function for music data.

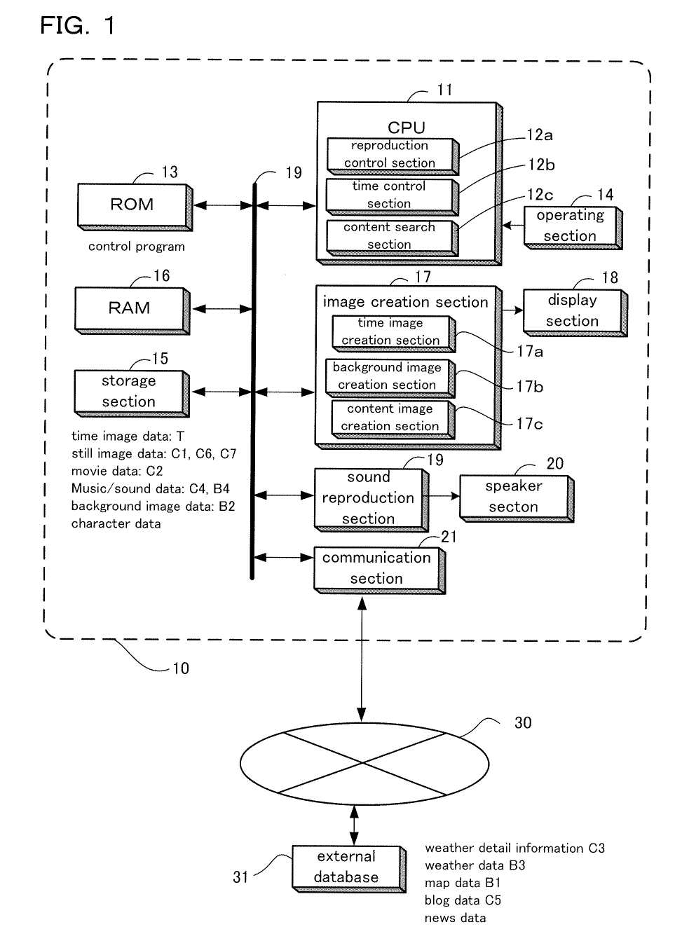

FIG. 1 is a block diagram showing the structure of a personal computer 10 relating to a first embodiment of the present invention. This personal computer 10 comprises a CPU (Central Processing Unit) 11, ROM (Read Only Memory) 13, operating section 14, storage section 15, RAM (Random Access Memory) 16, image creating section 17, display section 18, sound reproduction section 19, speaker section 20 and communication section 21.

The CPU 11, ROM 13, storage section 15, RAM 16, image creating section 17, sound reproduction section 19 and communication section 21 inside the personal computer 10 are connected by a bus 19. Also, the personal computer 10 is connected to an external data database 31 by means of the communication section 21 and a network such as the Internet 30, or the like.

The CPU 11 inside the personal computer 10 carries out overall control of the personal computer 10 in accordance with a control program stored in the ROM 13 that is constituted as a flash memory etc. Inside the CPU 11 there are provided a reproduction control section 12a, a time control section 12b and a content search section 12c, as processing functions, and although these functions are carried out by a control program within this embodiment it is also possible to realize the same functions with dedicated hardware. In the following, all content for the reproducing unit of the present invention, such as image, audio, music or documents will be generically referred to as data. Combinations of such data will be referred to as “multi-content”.

The reproduction control section 12a performs control of overall reproduction by determining reproduction time and order of content, background and time images etc. that will be described later. At the time of reproduction of these content, backgrounds and time images, this reproduction unit is operated in line with control time, and the time control section 12b performs this time control. The content search section 12c carries out a search for content having a creation time and date corresponding to a date that constitutes a reproduction object, from the storage section 15 inside the personal computer 10 etc., and from an external database 31.

The operating section 14 connected to the CPU 11 is constituted as a user interface such as a keyboard and a mouse, and inputs various operation commands to the personal computer. The image creating section 17 is hardware for creating an image for display from data such as content, and is made up of a time image creation section 17a, a background information creation section 17b, and a content image creation section 17c.

The time image creation section 17a is a creation section for creating a time circle image (also called time information) and an image having content or the like arranged in a thumbnail manner according to time of this time circle display (also called content information). Also, the background information creation section 17b is made up of a background image creation section for creating a background image, and a background music creation information section for creating background music. Here, a background image is an image displayed at the back of a screen in order to give variety to display content. Also, background music is music generated at the back of a screen in order to boost the atmosphere during image viewing. The “background image” and the “combination of background information and background music” are also called “background information.” The content image creation section 17c is a creation section for still images, movies and character images corresponding to individual content or the like displayed in a thumbnail manner within the time image. The display section 18 is connected to this image creation section 17, and images created by the image creation section 17 are displayed.

The storage section 15 is a storage section for storing various content data, and is made up of a large capacity storage unit such as a hard disc. Time circle image data T, still image data, music/voice data, movie data, background image data and character string data, etc. are stored in this storage section 15. As voice data, recorded conversations etc. are also stored, as well as music.

The sound reproduction section 19 reproduces sound data recorded in the storage section 15, and reproduced sound is output by the speaker section 20. Also, RAM 16 is used as a temporary storage region. Further, the communication section 21 performs transmission and reception to and from an external database 31 via the Internet 30, etc. As the external database 31, it is possible to connect to various archive databases such as a weather detail database, weather database, map database, blog data (WEB LOG), news database etc.

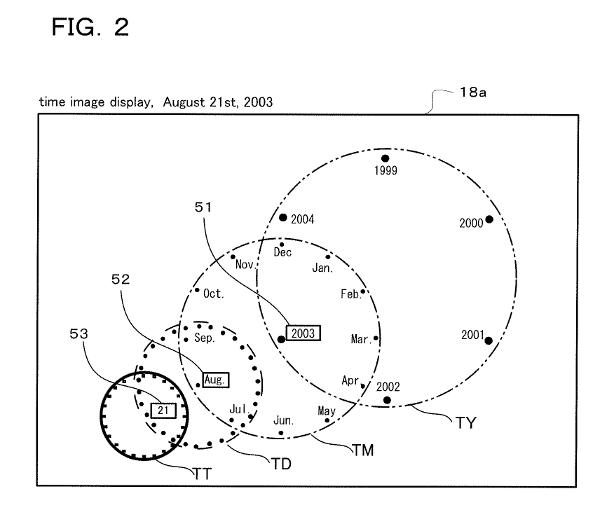

In this way, the reproducing unit of a first embodiment of the present invention is a personal computer normally commercially available, or a personal computer having an image creating section added to it, and is connected to an external data base by means of the Internet 30 or the like. This reproducing unit has a program for executing operations that will now be described in ROM 13. Before describing a flowchart relating to this program, description will be given of operation for the display and reproduction in the reproducing unit, using FIG. 2 to FIG. 10.

First, display of time circle images for selecting content to be reproduced using this embodiment based on content creation time and date will be described using FIG. 2. This time circle image is displayed on the display section 18, and is used when selecting year, month and day, and in display of year, month and day. First a year circle TY for displaying years in a circle shape is displayed on the display screen 18a. Each year from 1999 is displayed around this year circle TY, and if 2003 is selected from within this year display the year 2003 is displayed framed by the selection box 51. Only years up to 2004 have been shown in FIG. 2, but the years shown can be appropriately changed.

If the year is selected, then together with displaying that year with a box, the month circle TM is displayed. Months from January to December are displayed around this month circle TM, and if August (displayed as Aug. in FIG. 2) is selected from within this month display, then Aug. is displayed framed by the selection box 52. Together with the boxed display of this month selection, the day circle TD is displayed.

Dots representing days are displayed around this day circle TD, and if a dot corresponding to the 21st is selected from within this dot display the 21st is displayed framed by the selection box 53. Together with the boxed display of this day selection, the time circle TT is displayed.

In this manner, if selection is made in order from the year, circles are displayed in time order, and within this embodiment Aug. 21, 2003 is selected. Also, the selected year, month and day are displayed using the box displays 51, 52 and 53, and so it is possible to easily confirm the selected year month and day. Within this embodiment, the selected year month and day are displayed in a boxed fashion, but the embodiment is not limited to this boxed display, and it is possible to change to various display methods that change color or give flashing display etc.

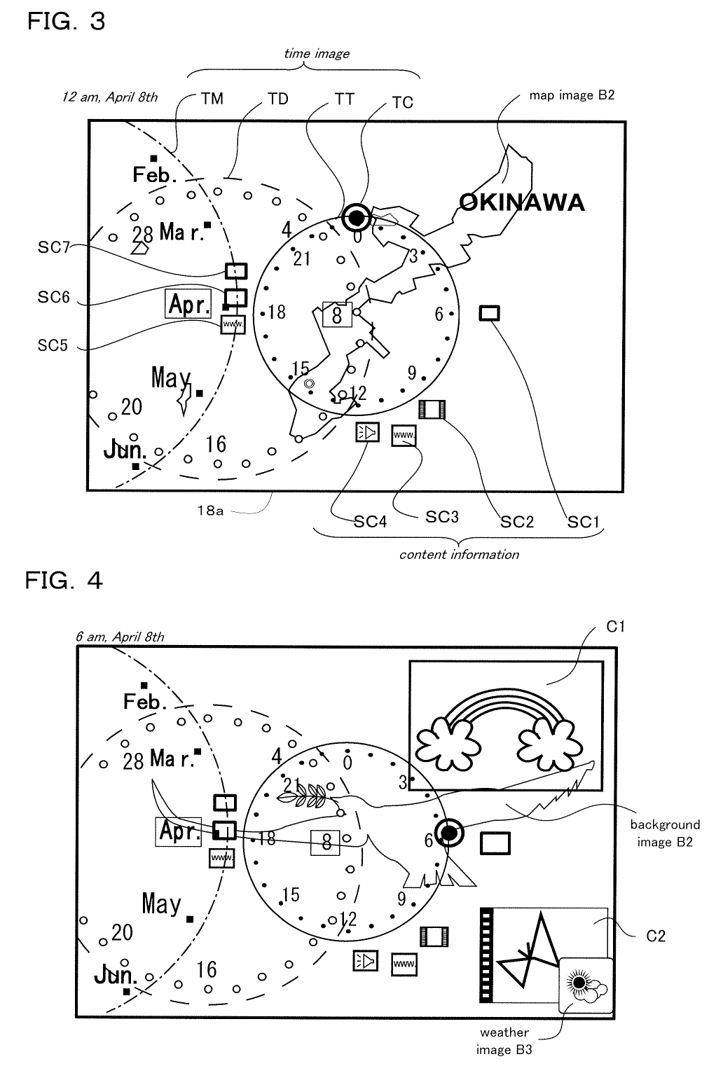

Next, reproduction of multi-content of this embodiment will be described using FIG. 3 to FIG. 8. Within this embodiment, an example of reproducing sequential multi-content in order to look back on memories of a trip (Okinawa) on Apr. 8, 2007 will be described. As multi-content, still pictures C1, C6, C7, a movie C2, text C3 that is a blog from the web and text C5 that is weather information from the web, and sound C4 are reproduced. As well as these content, a background image and background music are also displayed changing with time.

When reproducing multi-content, first selection of the years, months and days before reproduction, as described previously, is carried out. If this selection is carried out, the image shown in FIG. 3 is displayed (FIG. 3 is an example where 12 am, Apr. 8, 2007 has been selected). A cursor TC representing past elapsed time is positioned at the reproduction start time on the time circle TT. Various content that was created on April 8th is displayed round the circumference of the time circle TT as content thumbnails (SC1, SC2, SC3, SC4).

Here, SC1 is a thumbnail image of still image C1. Also, SC2, SC3 and SC4 are thumbnail images schematically representing movie C2, text C3 and sound C4. Similarly, SC5 is a thumbnail image of text C5, SC6 is a thumbnail image of still image C6, and SC7 is a thumbnail image of still image C7. Specifically, the content has information relating to the date and time it was created, and based on this information the content information image is arranged and displayed as a thumbnail image at a position corresponding to the creation time. A time image is formed from these time circle images and thumbnail images of the content information.

Also, as a background image for the time image, in FIG. 3 a map image B1 of the travel destination (Okinawa) is displayed. With this example, the travel destination is Okinawa, and so map data of the relevant region is searched for from an external database 31 based on GPS (Global Positioning System) information stored as a shooting location in content of the images, etc., and the map image B1 of the relevant region is used as the background image.

If reproduction display (slideshow) is started from the start screen of FIG. 3, the cursor TC starts moving on the time circle TT at a specified rate. Within this embodiment, the reproducing rate is set so that in actual fact the previous six hours are traversed in one minute, as will be described later (refer to Fog. 10). If the cursor TC approaches 6 am, then as shown in FIG. 4 the still image C1 that was taken at 6 am on Apr. 8, 2007 is displayed gradually larger. This still image C1 is an image corresponding to the still image SC1 that was thumbnail displayed.

As the background image, instead of the map image B1 the taken image B2 (image of a pigeon) that was selected beforehand appears, and this taken image B2 is moved from the left to the right in accordance with transition of time. Also, as another background image a weather image B3 is further displayed at the lower right. This weather image B3 is a weather image for the relevant day (in this example Apr. 8, 2007) acquired from the external database 31 by the content search section 12c, and is automatically displayed. If the weather information of the external database 31 is detailed, it can be changed in accordance with the time represented by the cursor TC. Here, weather information for 6 am, April 8th, is displayed.

Further, reproduction of the movie C2 that was taken around 9 am is started in accordance with movement of the cursor TC. This movie C2 is an image corresponding to the movie SC2 that was thumbnail displayed. As reproduction and display of the content information image transitions to the movie C2, reproduction and display of the still image C1 becomes gradually smaller.

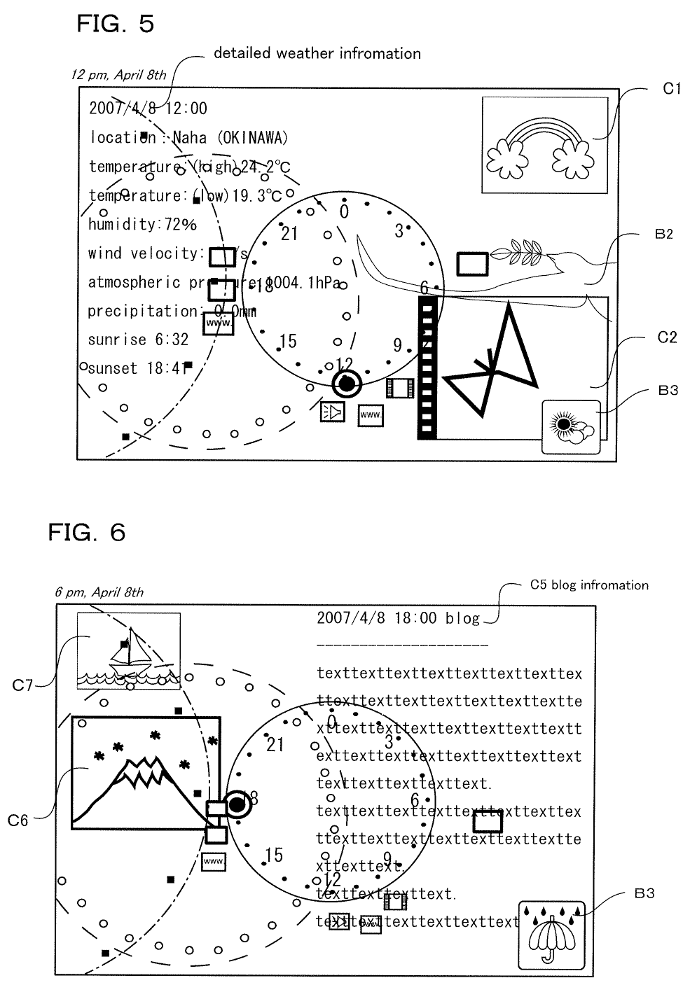

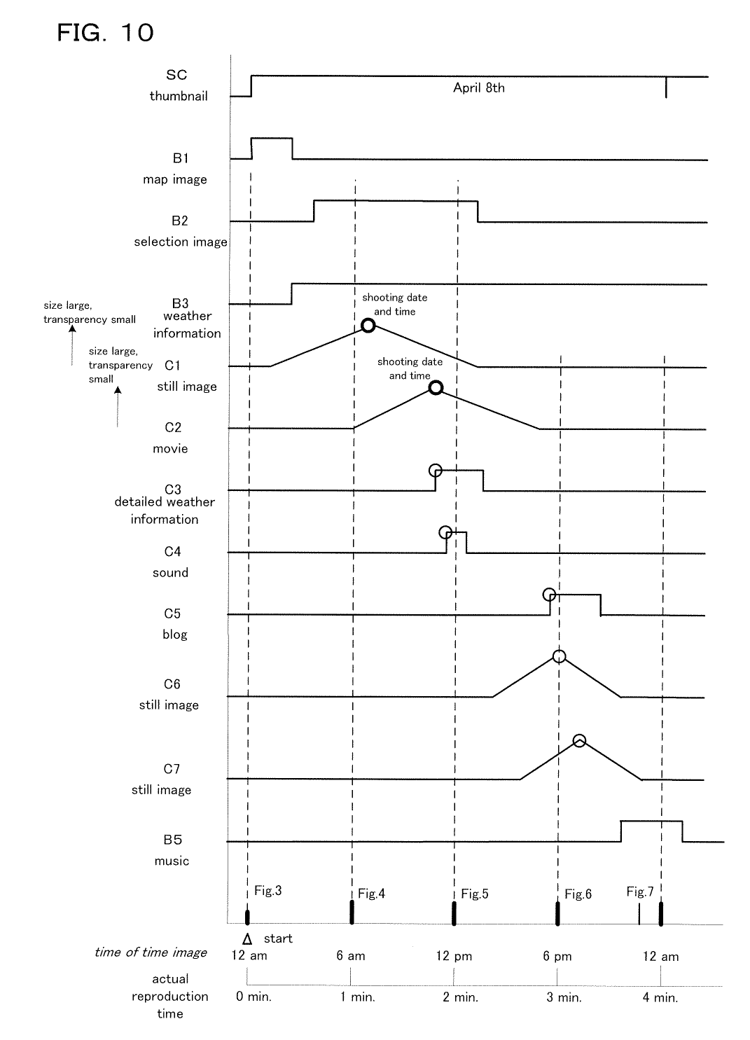

Next, if the cursor TC approaches around 12 pm, then as shown in FIG. 5 the still image C1 becomes smaller, and its density also decreases, to gradually disappear. The movie C2 becomes larger, and its density increases, to appear clearly. The text C3 corresponding to SC3 is displayed on the left side of the display screen 18a. Here, the text C3 is detailed weather information, and the display timing is previously set (refer to FIG. 10).

Each content is reproduced on the screen while varying the size and density thereof, but one example of this is shown in FIG. 10. FIG. 10 shows timing for reproducing each content on a time axis, and a few aspects of content reproduction will be simply described. The very top of the drawing shows display timing for thumbnail images, with thumbnail images being continuously displayed on a 24-hour basis. Below that is the display timing for map image B1, which is displayed from 12 am to about 3 am. Also, the fifth from the top shows display timing for the still image C1, which is reproduced with the display size gradually increasing from about 1 am, while the display density is also increased. The still image C1 is displayed at the maximum size at about 7 am, which is the time it was taken (section shown by circle mark), and after that conversely reduces in size, and reproduction is carried out so that display density becomes weaker and the image gradually disappears. The other still images C6 and C7 are also reproduced while similarly fading in and fading out. On the other hand, the detailed weather image C3 and the text (blog) C5 are reproduced at a specified timing without any special effects such as fading in and fading out.

Also, at the timing shown in FIG. 10 sound is reproduced based on the sound C4 corresponding to sound SC4, and is output from the speaker section 21. As an example of this type of sound, for example, a conversation with a friend that was recorded at about 12 pm on that day is used. Also, the taken image B2 which is the background image is moved to the right, and gradually disappears.

Further, if the cursor TC moves and approaches about 6 pm, then as shown in FIG. 6 text C5 corresponding to SC5 (specifically a blog) is displayed as characters. The blog can also be the blog of another person, and it is also possible to display the blog of this person. This text C5 is searched from the external database 31 by the content search section 12c.

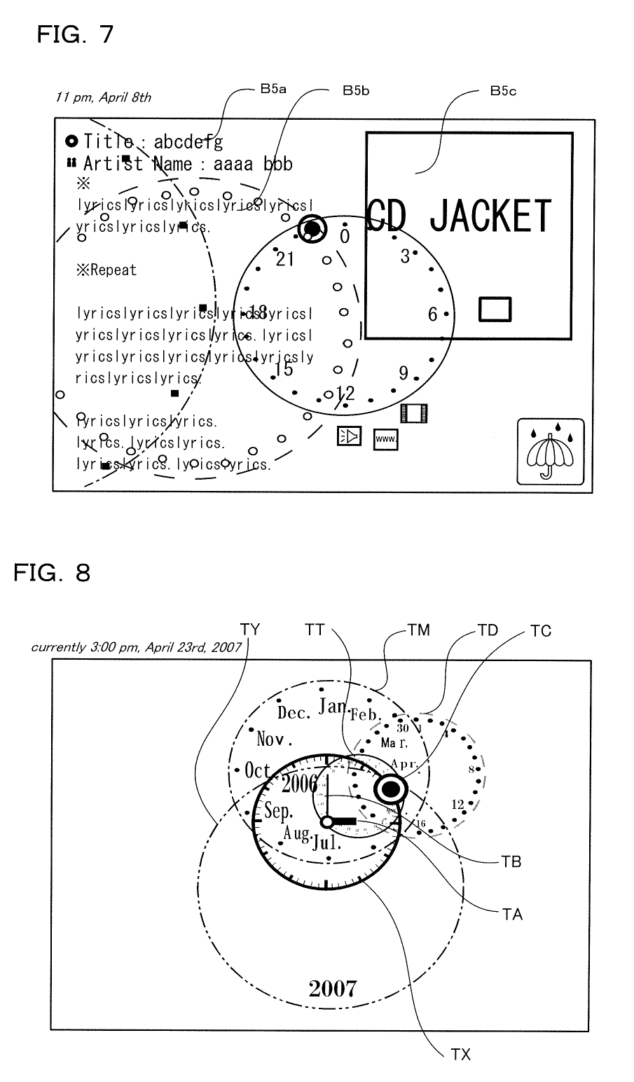

Also, still images C6 and C7 corresponding to the thumbnail images SC6 and SC7 are reproduced and displayed, and are displayed gradually larger with time. Also, the weather image B3 displayed at the lower right is updated in accordance with movement of the cursor TC. If the cursor TC approaches 11 pm, predetermined album title B5a, lyrics B5b and CD jacket image B5c are displayed as a background image, as shown in FIG. 7. Also, as the background music, music B5 corresponding to this is reproduced, and output from the speaker section 21. If 24 hours have elapsed, it is possible to terminate display, and it is also possible to carry out similar reproduction and display of content for April 9th, and to repeat reproduction and display substituting the date every 24 hours. In any event this can be set before hand.

In this manner, the time circle image T and thumbnail displayed content information image, and background image and background music, are reproduced and displayed by means of the display screen 18a and the speaker section 21. As the content information image, content comprised of still pictures C1, C6, C7, a movie C2, text C3 and C5 and sound C4 is reproduced. Also as background image and background music, the map image B1, taken image B2, weather image B3, music B5 and linked images B5a, B5b and B5c related to that music, are reproduced and displayed.

Also, at the time of reproduction, starting from 12 am on Apr. 8, 2007, until 12 pm on that day, the above described content and background images are sequentially reproduced in accordance with movement of the cursor TC on the time circle image T, under the control of the time control section 12b. Reproduction states of the above described background image and contents are shown in FIG. 10. In FIG. 10, the horizontal axis is time, and the vertical axis is content and background images, and the drawing shows reproduction states of the content and images.

As has been described above, if a current time has been reached (with this example, 3 am on Apr. 23, 2007) after starting from 12 am on April 8th, a slideshow for displaying the multi-contents in combination is completed. If the slideshow is ended, it is possible to make a transition to the next day, as described above, and it is also possible to terminate display, but as shown in FIG. 8 it is also possible to carry out clock display representing the current time. As the clock display, a short hand TA and a long hand TB are displayed on a clock face TX. At this time, the time circle image described using FIG. 2 is also displayed. Specifically, if the year circle TY, month circle TM, day circle TD, time circle TT and cursor TC are displayed, not only is it easy to see the time, but the year, month and day can also be understood at a glance. Naturally, it is also possible to display only the clock face, and omit display of each of the circles.

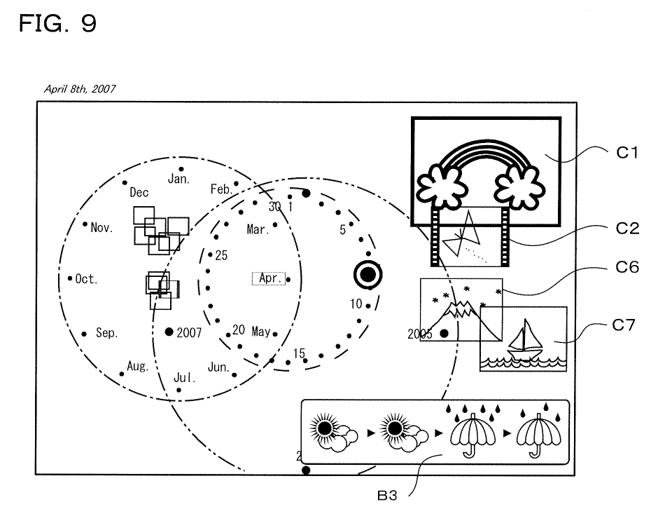

In the description of the first embodiment of the present invention, reproduction is carried out by sequentially switching content in one day units, that is, according to transition of the cursor TC on the time circle TT. However, this is not limiting, and as shown in FIG. 9 it is also possible to carry out reproduction by switching content sequentially in month units, that is, in accordance with transition of the cursor TC on the day circle TD. With the example of FIG. 9, the cursor TC is at April 8th, and at this time still images C1, C6 and C7 are reproduced and displayed, and the weather image B3 displays transition of weather for one day of April 8th.

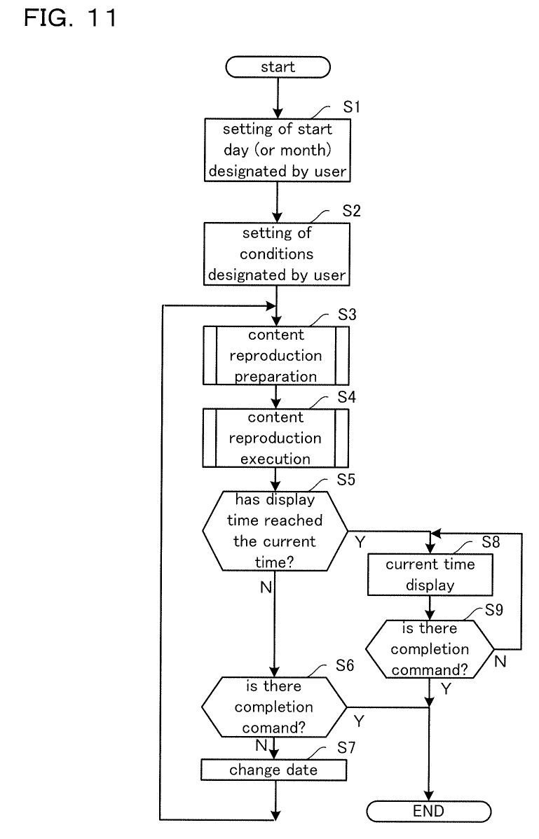

Next, a procedure for executing the above described reproduction and display will be described using the flowcharts shown in FIG. 11 to FIG. 16. A program for carrying out reproduction and display in the first embodiment of the present invention is started. First, a start day is set by a user designation (S1). With the example of FIG. 3, 12 am on Apr. 8, 2007 is designated. It is not necessary for the start time to be 12 am, and it is possible, for example, for the user to designate a start time by moving the cursor TC with a mouse. Also, with the modified example of FIG. 9, display is possible in month units, but in this flowchart designation is in day units and reproduction is carried out. This designated day is called the relevant day in the following. If designation is performed by month, it becomes the relevant month.

Next condition setting is carried out by the user (S2). The condition setting here is performing of condition setting such as the procurement and display of background image and background music, and weather information. Weather information is procured using the external database 31, and so it is possible to set a URL (Uniform Resource Locator) that can procure the weather information. Also, it is possible to set a general background image and background music as a default for the condition setting, and have the user be able to freely alter this setting.

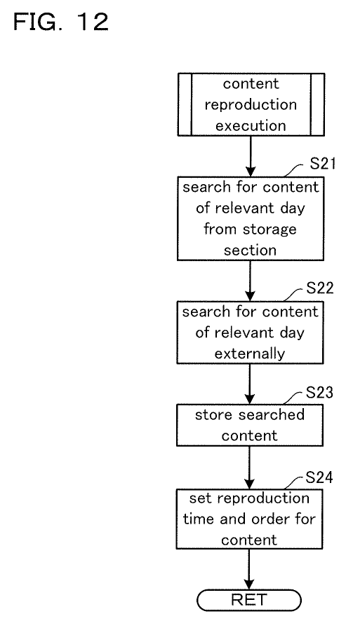

If the condition setting is completed, content reproduction preparation is then carried out (S3). This content reproduction preparation is the performing of search for data or the like relating to the relevant day by the content search section 12c, under the control of the reproduction control section 12a. Specifically, this is processing to search for data relating to the relevant day from image data, sound data and character data that is stored in the storage section 15 etc. inside the personal computer 10, and from the external database 31, store the searched data for reproduction, and determine the reproduction order. Details will be described later using FIG. 12.

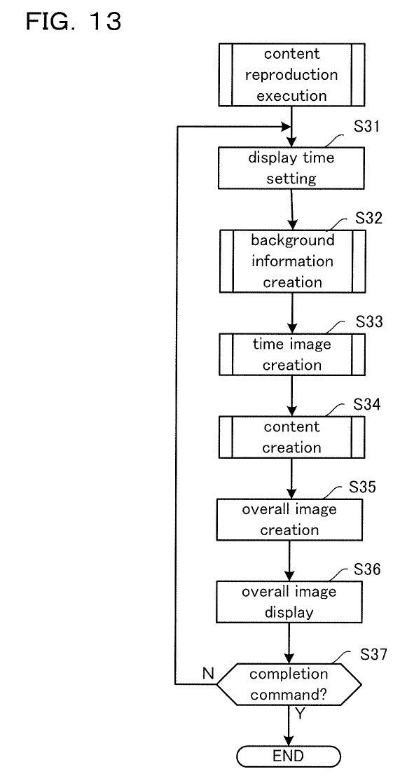

If the content reproduction setting is completed, content reproduction execution is then carried out (S4). Here, the image creation section 17 creates a time image and a background image (background information) under the control of the reproduction control section 12a, and carries out reproduction of content such as still images, movies, text and music/sound, as shown in FIG. 3 to FIG. 7. With the content reproduction preparation of step S3, content preparation is carried out for one day's worth of the relevant day, and this one day's worth of content is reproduced in order. Details will be described later using FIG. 13.

Next, determination as to whether a display time has reached the current time is carried out (S5). With respect to the current time here, it is determined whether the year, month, date and time set for display has reached the current time, and if the display time has reached the current time the content reproduction is completed. If the result of determination is that the current time has been reached, it is determined whether there has been a reproduction display termination command (S6). The termination command is performed using the operation section 14.

If the result of determination in this step 6 is that a termination command has not been issued, the date is updated (S7). With this example, the start is at 12 am Apr. 8, 2007, but initially, during this step it can be updated to Apr. 9^{th}, 2007. After that, the date is increased every one day at a time through step S7, processing returns to step S3, and reproduction preparation for content corresponding to the relevant day is carried out.

If the result of determination is step S5 is that the display time has reached the current time, then display of the current time is carried out using the clock face TX shown in FIG. 8 (S8). Following on, similar to step S6, it is determined whether there is a termination command, and if the result of determination is that there is not a termination command processing returns to step S8, and time display is continued. If the results of determination in step S9 or step S6 are that there is a termination command, the processing of this flowchart is terminated.

Next, details of a sub-routine for the content reproduction preparation of step S3 will be described using FIG. 12. First, the content search section 12c searches for content of the relevant day from the storage section 15 (S21). Specifically, image data taken using a digital camera, a video camera, or camera of a mobile phone or the like, and sound data etc. recorded using an IC recorder, has creation date information attached thereto and is stored in the storage region of the storage section 15. The content search section 12c searches for image data and sound data that was created on the relevant date based on the attached creation date information.

Next, the content search section 12c searches for content of the relevant day from the external database 31 (S22). Weather data (B3), weather detail data (C3), text (for example blog) data (C5) and news data etc. are searched for based on a URL that is set in advance. Also, map data (B1) is searched for from GPS data having an image for the relevant day attached. It is also possible to search for data of the relevant day using an Internet search engine.

Next, the data searched for and acquired in step S21 and step S22 is stored by the CPU 11 in a reproduction region of the storage section 15 (S23). Next, reproduction time and order for content is set (S24). Specifically, the reproduction control section 12a determines reproduction time (display time controlled by the time control section 12b) based on creation time and date information that is attached to acquired image data, sound data, text data, news data etc., and sets this reproduction order.

Although not shown in the drawings, after step S24 it is also possible to add a user edit mode as an option. With the edit mode, it is preferable for the user to be able to carry out selection, etc. of images and sounds they wish to reproduce, for sound and movies.

Next, details of a sub-routine for the content reproduction execution of step S4 will be described using FIG. 13. This content reproduction execution is controlled by the reproduction control section 12a.

First of all, setting of display time is carried out (S31). With the example of FIG. 3, the display time is set to start from 12 am on Apr. 8, 2007, and be for 5 minutes, for example. With this example, as shown in FIG. 10, an actual time of six hours is displayed fast-forwarded in one minute, and so if display time is set in increments of 5 minutes, and if 5/360th of a minute elapses at the current time, the display time will be advanced by 5 minutes. Time control here is performed by the time control section 12b.

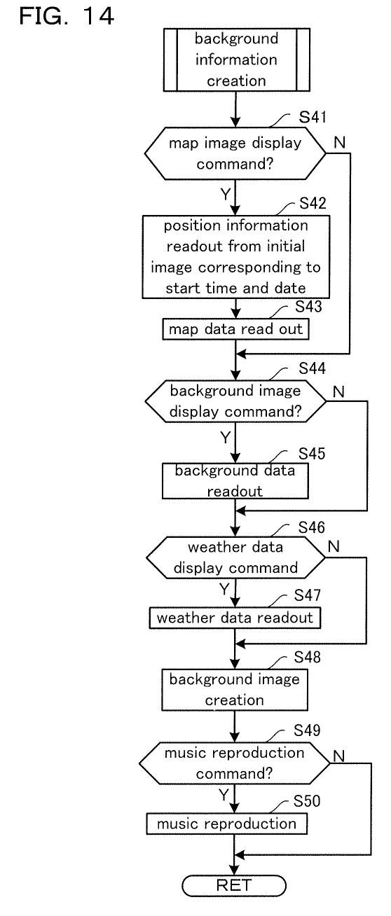

Next, creation of the background image is carried out (S32). With this subroutine, reproduction of the map image B1, background image B2, weather image B3, background music B5 and linked images B5a, B5b and B5c related to that music, are carried out. Details will be described later using FIG. 14.

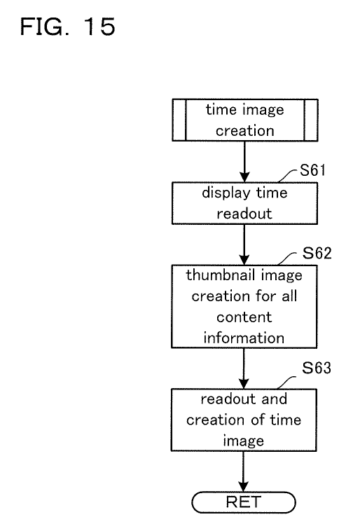

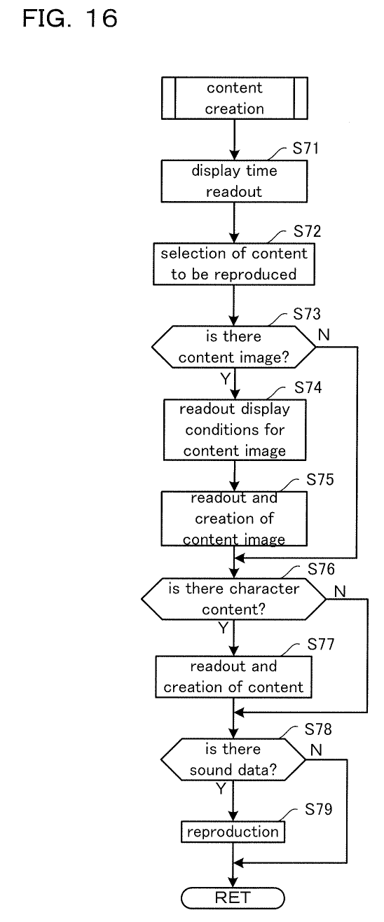

Next creation of a time image is carried out (S33). With this subroutine, a time image formed from a time circle image and a content information image is created based on the display time. Details will be described later using FIG. 15. Next, creation of content is carried out (S34). With this subroutine, creation of content used for reproduction is carried out based on image data, sound data, and text data etc. stored in the storage section 15. Details will be described later using FIG. 16.

Next creation of an overall image is carried out (S35). The background image, time image and content that were created based on the display time set in step S31 are combined to give an overall image.

Next, display of this created overall image is carried out (S36). If display of the overall image is carried out, it is determined whether a termination command has been issued (S37), and if a termination command has been issued execution of this processing flow is terminated, while if a termination command has not been issued processing returns to step S31. Also, if reproduction of one days content for the relevant day that was prepared by the content reproduction preparation subroutine is completed, termination is instructed, and processing returns to the main routine of FIG. 11.

Next, details of a sub-routine for the background information creation of step S32 will be described using FIG. 14. The processing flow here is executed by the reproduction control section 21a inside the CPU 11, and the background information creation section 17b. First, it is determined whether or not there is a command for map image display corresponding to the display time that was set in step S31 (S41).

If the result of determination in step S41 is that there is no command, processing skips to step S44, while if there is a command position information is read from an image that was initially taken among images corresponding to the relevant day (S42) and reading of map data (B1) is carried out based on this read position information (S43). Here, as described previously, since position information using GPS is stored in image data taken with a digital camera or the like, reading of map data (B1) corresponding to this position information is carried out.

Next, it is determined whether or not there is a command for background image display corresponding to the display time (S44). If the result of determination is that there is no command, processing skips to step S46, but if there is a command reading of background data (B2) is carried out (S45). The background data (B2) is, for example, image data corresponding to the background image B2 of FIG. 4.

Next, it is determined whether or not there is a display command for weather data corresponding to the display time (S46). If the result of determination is that there is no command, processing skips to step S48, but if there is a command, reading of weather data is carried out (S47). Here, as described previously, in step S22 weather data for the relevant date is acquired and stored using the external database 31, and so reading of this weather data is carried out.

Next creation of a background image is carried out (S48). With this step, a background image is created based on the read data, specifically the map data (B1) read in step S43, the background data (B2) read in step S45, and the weather data (B3) read in step S47.

If the creation of the background image is completed, it is next determined whether or not a command has been issued for music reproduction, corresponding to the display time (S49). If the result of determination is that a command has not been issued, the original processing flow is returned to, but if a command has been issued music data stored as background music is read out and reproduced (S50). The display time is a controlled time, but when reproducing music, there is no fast forward and it is actual time. However, it is also possible terminate music reproduction midway through. Once the music reproduction is finished, the original processing flow is returned to.

Next, details of a sub-routine for the time information creation of step S33 will be described using FIG. 15. The processing flow here is executed by the reproduction control section 12a and the time image creation section 17a inside the CPU 11. First, reading of display time set in step S31 is carried out (S61). Following that, creation of thumbnail images for all content information belonging to the relevant day is carried out (S62) based on relevant day information contained in that display time.

Next reading and creation of a time image is carried out (S63). In this step, a time circle image arranged according to the display time represented by the cursor TC and the thumbnail images created in step S62 are combined, to create a time image. Once the time image creation is finished, the original processing flow is returned to.

Next, details of a sub-routine for the content creation of step S34 will be described using FIG. 16. The processing flow here is executed by the reproduction control section 12a and the content image creation section 17c inside the CPU 11. First, reading of display time set in step S31 is carried out (S71). Next, selection of content to be reproduced according to this reproduction time is carried out (S72). In this step, reproduction content (images, characters, sound, text etc.) is selected based on content information acquired and stored in steps S21 to S23.

If the reproduction content is selected, it is next determined whether or not there is image content within these reproduction contents (S73). If the result of determination is that there is no image content, processing skips to step S76, but if there is image content reading of display conditions for the content image is carried out (S74)

In the example of this embodiment, as the content there are still images and movies (C1, C2, C6, C7), weather detail information C4 and text C5 etc., but among these image content such as the still images and the movies are selected, and display conditions for these image content, for example setting conditions such as size and density of the images, are read. Next, reading and creation of content images is carried out (S75).

It is next determined whether or not there is character content within these reproduction contents (S76). If the result of determination is that there is no character content, processing skips to step S78, but if there is character content, reading and creation of character content is carried out (S77). As character content, there are weather detail information C4 and blog etc. Also, if there is a diary entry written that day, that can be displayed, and if there is news for the relevant day that can also be read and created.

If the creation of character content is completed, it is next determined whether or not there is sound content within these reproduction contents (S78). If the result of determination is that there is no sound content, the original processing flow is returned to, while if there is sound content reproduction of sound content is carried out (S79) and the original processing flow is then returned to.

With reproduction of only images, as in the related art, it may result in a dull slideshow, and even if music is simply mixed in, there is no real increase in the level of enjoyment. By reproducing sound that has been recorded at the time of taking an image, or weather, blog or news at that time, together with the image, as in the first embodiment of the present invention, the atmosphere at the time in question can be simply reproduced, and compared to simply viewing images it is possible to evoke those memories. It is possible to realize a novel reproducing device and reproducing method that is appropriate to the Internet age.

With the reproducing device of the first embodiment of the present invention, for content having time and date information, content having time and date information corresponding to that time and data information is searched for, and displayed according to time information. A plurality of types of content are also searched for. For this reason, the effect is realized of being able to use content of different categories, such as images, text, sound and music.

Also, within this embodiment, with time (display time) controlled by the time control section 12b as a base, display is performed linked to the date and time information of the content, which means that it is very convenient in looking back over memories and making a presentation.

Further, within this embodiment, when searching for content the reproducing device connects to the external database 31, and acquires content from this external database 31, which means that it is possible to enrich the content. When acquiring this content, creation time and date information is acquired, and the acquired content is reproduced together with other content based on this creation time and date information, which means that it is possible to perform integrated control.

Further, within this embodiment, the background information creation section 17b is provided, and not only a time image and content image, but also a background image are displayed, which make it possible to make the whole experience more enjoyable. In particular, a background image (background music) is associated with a time (display time) when it is to be controlled by the time control section 12b, and altered, and in this way it is possible to further increase enjoyment without reproduction being dull.

Further, within this embodiment, by displaying a map image, weather image or news image etc. as a background image, it is advantageous when looking back over memories or presenting an event. Also, with the embodiment of FIG. 3 etc. an example has been shown of constant display of a weather image (B3), but it is also possible, instead of the weather image, to display sports information or stock market information depending on the user. It is possible to handle change in URL information of the external database 31.

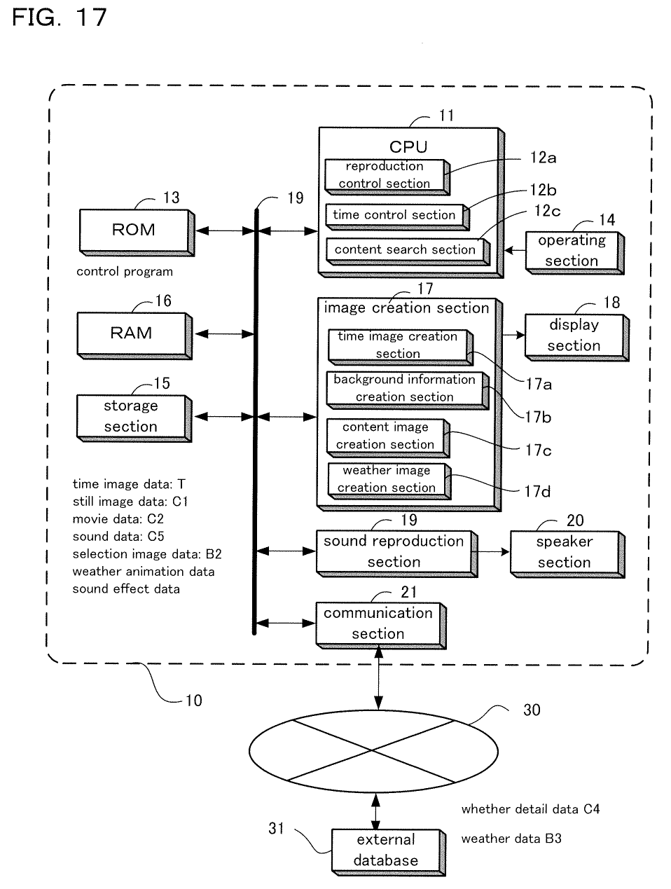

Next, a second embodiment of the present invention will be described using FIG. 17 to FIG. 27. In the first embodiment of the present invention, content is sequentially displayed according to time information, and in the event that there is no content corresponding to the time information nothing is displayed. With the second embodiment of the present invention, in the event that there is no content corresponding to the time information, some kind of display, for example information from a home page on a designated web site, is acquired and displayed, so as to make the screen more appealing.

In the following, a preferred second embodiment using a reproducing unit adopting the present invention will be described using the drawings. With the second embodiment also, the reproducing unit is capable of connection to the Internet, and is capable of storing movies and still pictures etc., and is constructed using a personal computer having a reproducing function for these images.

FIG. 17 is a block diagram showing the structure of a personal computer 10 relating to this embodiment. Similarly to the first embodiment, this personal computer 10 comprises a CPU (Central Processing Unit) 11, ROM (Read Only Memory) 13, operating section 14, storage section 15, RAM (Random Access Memory) 16, image creating section 17, display section 18, sound reproduction section 19, speaker section 20 and communication section 21. In the following, structures that are the same as the first embodiment have the same reference numbers attached, and detailed description there of is omitted, with description centering on points of difference.

The content search section 12c inside the CPU 11, similarly to the content search section 12c of the first embodiment, performs a search for content having a creation time and date corresponding to the relevant day (display time) that is the reproduction objective, from the storage section 15 etc. inside the personal computer 10 and from the external database 31, and when performing this search it is also possible to search for weather data of the relevant date for display on a weather screen.

The image creation section 17 is hardware for creating images for display from data such as content, and similarly to the first embodiment has a time image creation section 17a, background information creation section 17b and content image creation section 17c, and also has a weather image creation section 17d.

The weather image creation section 17d creates a weather animation in order to display at the time of a weather screen. The previously described reproduction control section 12a reproduces a weather animation that has been created based on searched weather data.

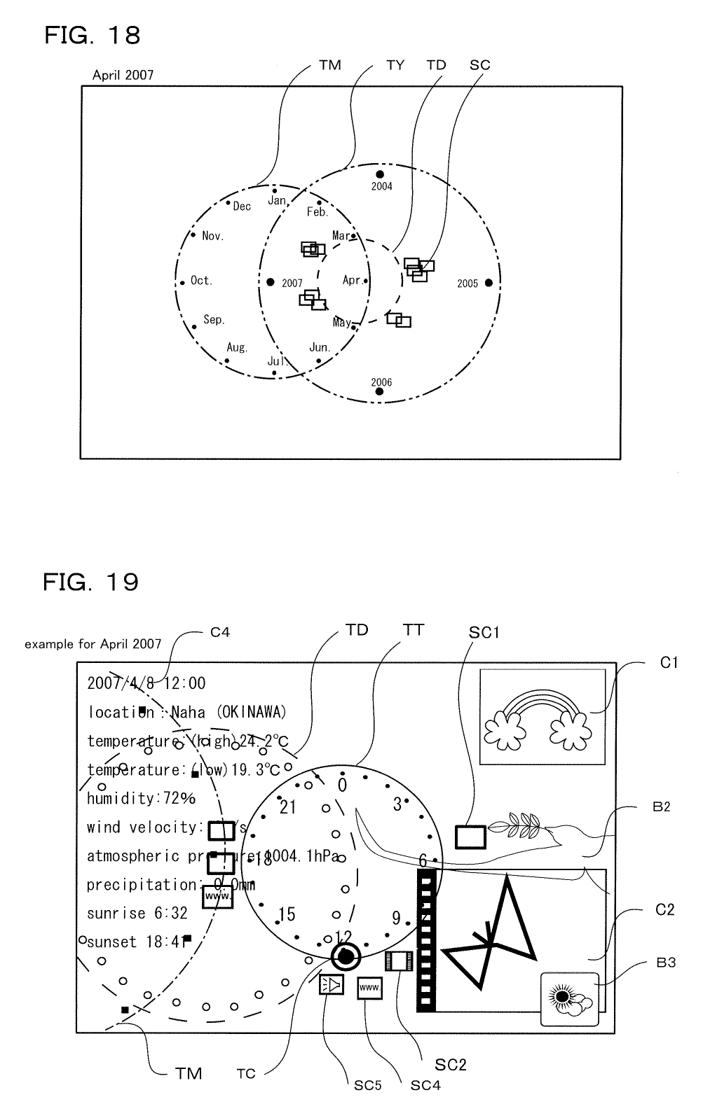

In this way, the reproducing unit of the second embodiment of the present invention, similarly to the first embodiment, is a personal computer 10 normally commercially available, or a personal computer having an image creating section added to it, and is connected to an external data base 31 by means of the Internet 30 or the like. This reproducing unit has a program, for executing operations that will now be described, stored in ROM 13. Before describing a flowchart relating to this program, description will be given of operation for the display and reproduction in the reproducing unit, using FIG. 18 to FIG. 25. This embodiment also performs display using a time image similar to the first embodiment, and detailed description thereof is omitted.

Within this embodiment, an example of reproducing sequential multi-content in order to look back on memories of a trip (Okinawa) on Apr. 8, 2007 will be described. As the multi-content, still pictures C1, movie C2, text (weather detail information via the web) C4 and sound C5 is reproduced and displayed. As well as these content, a background image B2 and background music are also displayed changing with time.

When reproducing the content, similarly to the first embodiment, selection of year and month is carried out. If this selection is carried out, the image shown in FIG. 18 is displayed (FIG. 18 is an example in which April, 2007 has been selected). Various content thumbnails SC are displayed around the circumference of the day circle TD. Specifically, the content has information relating to the year, month and day it was created, and based on this information the content information image is displayed as a thumbnail image at a position corresponding to the creation day. A time image is formed from these time circle images and thumbnail images of the content information.

With the example of FIG. 18, a movie and still images exist on April 2007, and so content thumbnails SC are displayed on the circumference of the day circle TD. The content thumbnails SC are minified images in the case where the content is an image, and in cases other than when the content is an image, a symbol mark is displayed.

If day selection is carried out, the image shown in FIG. 19 is displayed (FIG. 19 is an example where Apr. 8, 2007 has been selected). Content thumbnails SC1-SC5 are displayed around the time circle TT. If reproduction display (slideshow) is started from the start screen, the cursor TC representing the time image starts moving on the time circle TT at a specified display speed controlled by the time control section 12b. As the display speed, for example, it is set so that 6 hours in real time is transitioned in 1 minute.

If the display time reaches the time and date the respective content was created, in principle reproduction of corresponding content is commenced. However, for image content reproduction is started a little earlier at a low density and small size, so that it is at full density and size by the time the date and time it was taken is reached, and after that display is performed so as to reduce the size again.

If the cursor TC approaches 12 pm, then as shown in FIG. 19 the still image C1 that was taken at 6 am on Apr. 8, 2007 is displayed gradually smaller, and with density reducing to gradually fade out. This still image C1 is an image corresponding to SC1 that was thumbnail displayed. Also, the movie C2 that was taken at about 10 am can be seen clearly with the screen still large, and density full. This movie C2 is an image corresponding to SC2 that was thumbnail displayed.

Also, the detailed weather information C4 in the form of text corresponding to SC4 is displayed on the left side of the display screen 18a. Also, although not shown, sound corresponding to the sound SC5 is reproduced, and output from the speaker section 21. As sound, for example, a conversation with a friend that was recorded at about 12 pm on that day is used.

Further, the background image B2 which is one of the background images, is moved to the right, and gradually disappears. Also, as another background image a weather image B3 is displayed at the lower right. This weather image B3 is weather information acquired from the external database 31 by the content search section 12c based on the relevant day (in this example Apr. 8, 2007), and position information based on GPS information attached to image data etc., and is automatically displayed. If the weather information of the external database 31 is detailed, it can be changed in accordance with the time represented by the cursor TC.

In this way, a time image comprised of a time circle image T and content information images for thumbnail display, content comprising the still image C1, movie C2 and sound C5, and the background image B2 and the weather image B3 are reproduced and displayed using the display screen 18a and speaker section 21. Also, at the time of reproduction and display, starting from 12 am on Apr. 8, 2007, until 24 hours later that day, the above described content and background images are sequentially reproduced in accordance with movement of the cursor TC on the time circle image T, under the control of the time control section 12b. The start time for these slideshows can be changed by positioning the cursor TC at the start position using a mouse or the like.

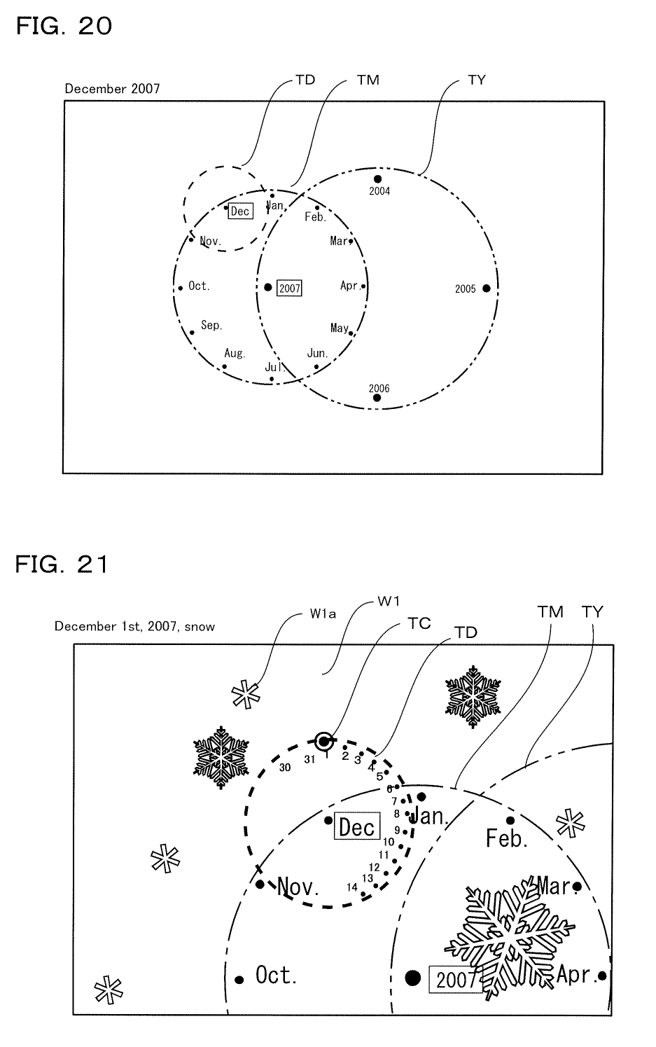

With the example shown in FIG. 18, thumbnails SC exist on the circumference of the day circle TD, but an example where images for the relevant month do not exist is shown in FIG. 20. The example of FIG. 20 is a case where December 2007 has been set, and content such as images does not exist for December. For such a month, even if the slideshow as shown in FIG. 19 is executed, no content is reproduced, and an uninteresting screen is presented.

Therefore, within this embodiment, for such a month weather information for a relevant day is displayed, as shown in FIG. 21 to FIG. 23. This weather information is data for the relevant day acquired from the external database 31, as previously described. The example of FIG. 21 is for Dec. 1, 2007, and if there is snow as the weather information for that day, an animated image of snow is displayed as a weather screen.

Specifically, the weather image creation section 17d creates a snow image W1 that is made up of snow symbols W1a etc. designed in the shape of snow flakes to be displayed as an animation. This snow image W1 is then reproduced by the reproduction control section 12a. When carrying out the animation display, it is possible to create an atmosphere of falling snow by moving the snow symbols W1a from top to bottom on the screen 18a.

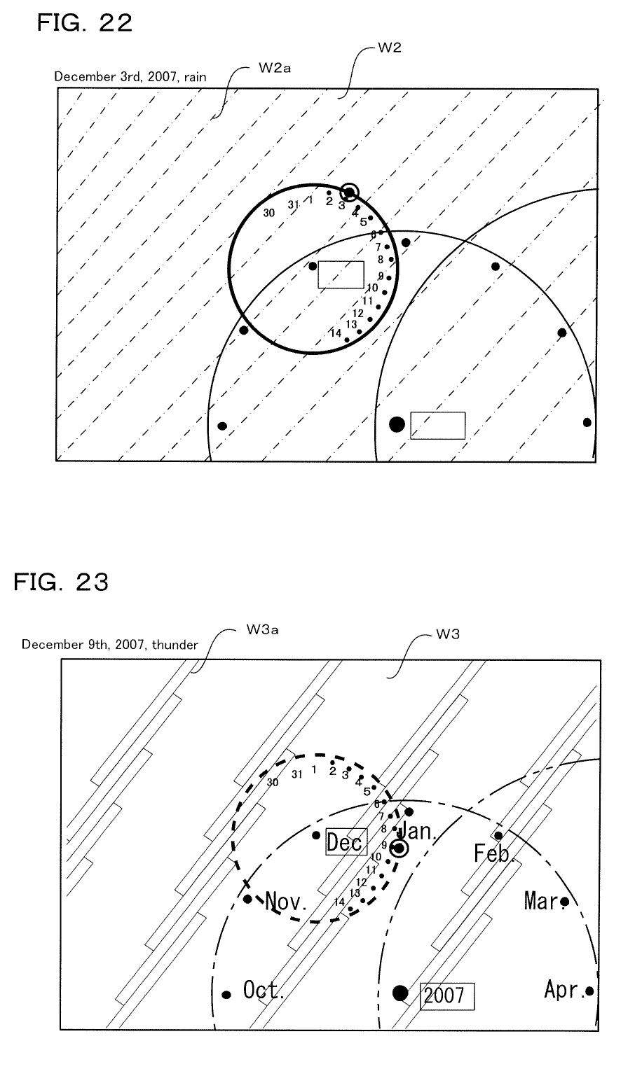

Also, the example of FIG. 22 is an example of Dec. 3, 2007, and for this day the weather information acquired from the external database 31 is for rain. In this case, as shown in the drawing, a rain image W2 containing rain symbols W2a designed as raindrops is created by the weather information creation section 17d, and displayed as an animation. Using the animation display, it is possible to create an atmosphere of falling rain by moving the rain symbols W2a from top to bottom on the screen 18a.

Also, the example of FIG. 23 is an example of Dec. 9, 2007, and for this day the weather information acquired from the external database 31 is for thunder. In this case, as shown in the drawing, a thunder image W3 containing thunder symbols W3a designed as streaks of lightning is created by the weather information creation section 17d, and displayed as an animation. Using the animation display, it is possible to create an atmosphere of flashes of lightning by causing the thunder symbols W3a to move from top to bottom on the screen 18a, like lightning.

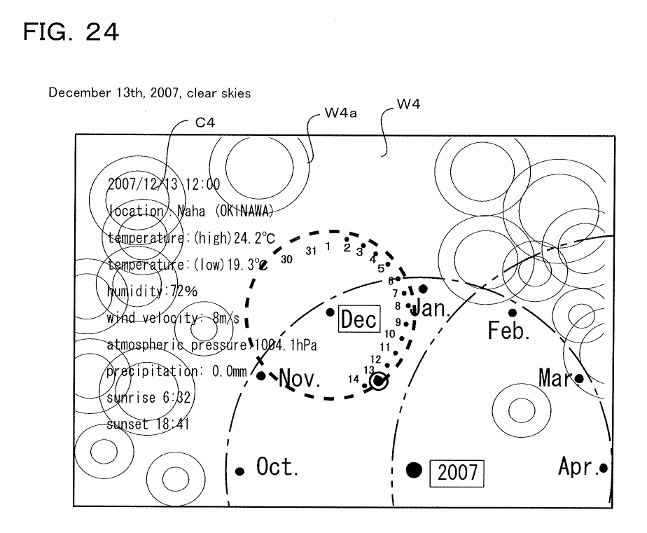

Also, the example of FIG. 24 is an example of Dec. 3, 2007, as the relevant day, and for this day the weather information acquired from the external database 31 is for clear skies. In this case, as shown in the drawing, a clear sky image W4 containing clear sky symbols W4a designed as the sun is created by the weather information creation section 17d, and displayed as an animation. Using the animated display, the clear sky symbols W4a are moved freely around on the screen 18a, and it is possible to create an atmosphere of fine weather.

In this way, within this embodiment, display is carried out by switching the weather images W, such as the snow image W1, rain image W2, thunder image W3 and clear sky image W4, based on weather information. As a result, when displaying content such as images in order of the day they were taken, even if there is no content corresponding to a long period of time, since the weather images W are displayed it is not tedious for the user. Also, displaying weather images is helpful in evoking memories, such as in a slideshow. As shown in FIG. 24, it is also possible to display text (characters) for detailed weather information C4 together with the weather images W.

It is also possible not only to display the weather image W based on the weather information, but to reproduce in combination with sound effects, based on the weather information. Specifically, a sound effect stored in the storage section 15 is read out based on the weather information, this sound effect is reproduced in the sound reproducing section 19, and the sound effect is reproduced from the speaker section 20.

As sound effects, there is the sound of walking on snow for the case of snow, the sound of rain for the case of rain, and the sound of thunder for the case of thunder, and for fine weather days bird calls, and the sound of wind for windy days. By using these sound effects, it is possible get a feeling of the weather of the relevant day not simply by visual observation, but also from hearing.

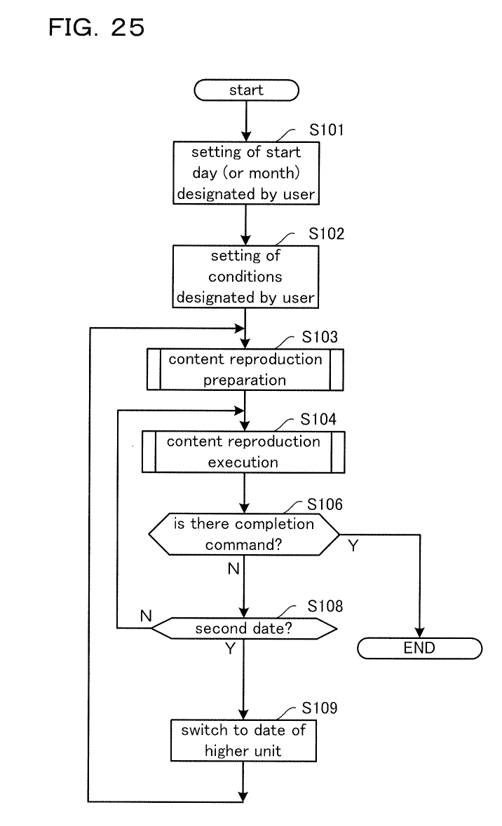

Next, a procedure for executing the above described reproduction and display will be described using the flowcharts shown in FIG. 25 to FIG. 27. If a program for carrying out the reproduction and display of this embodiment starts, a start day is first set by the user (S101). With the example of FIG. 19, 12 am on Apr. 8, 2007 is set, while with the example of FIG. 21 December 2007 is set. It is not necessary for the start time to be 12 am or one day, and it is possible, for example, for the user to designate a desired start time or day by moving the cursor TC with a mouse.

Next condition setting is carried out by the user (S102). The condition setting here is performing of condition setting for background image B2, background music, and weather information B3. The setting for weather information B3 is carried out using the external database 31, and so it is possible to set a URL that can procure the weather information. Also, it is possible to set a general background image and background music as a default, and have the user be able to freely alter this. Setting is performed such that with the example of FIG. 19, reproduction is carried out in “day” units, and with the example of FIG. 21 reproduction is carried out in “month” units.

If the condition setting is completed, content reproduction preparation is then carried out (S103). With the example of FIG. 19, this content reproduction preparation is the performing of search for data or the like relating to the relevant day by the content search section 12c, under the control of the reproduction control section 12a. Specifically, this is processing to search for data relating to the relevant day from image data, sound data and character data that is stored in the storage section 15 etc. inside the personal computer 10, and from the external database 31, store the searched data for reproduction, and determine the reproduction order.

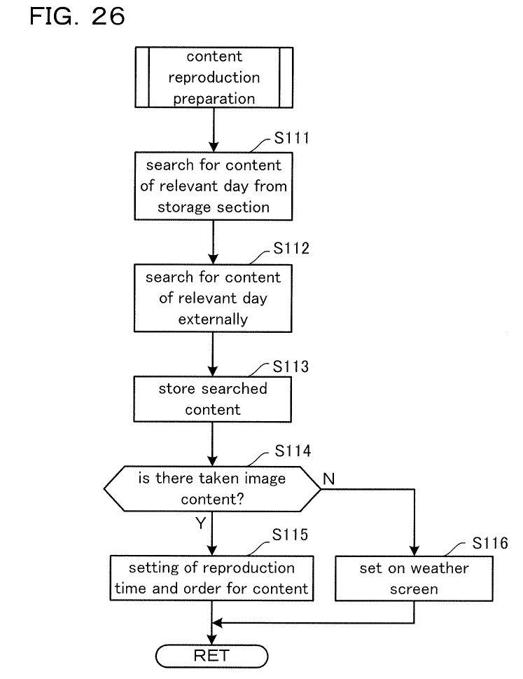

With the example of FIG. 21, for the relevant month preparation is carried out similarly for the case of the relevant day. Also, for both the example of FIG. 19 and the example of FIG. 21, in the event that there is no content to be reproduced, preparation of a weather image W is carried out. Details will be described later using FIG. 26.

If the content reproduction setting is completed, content reproduction execution is then carried out (S104). Here, the image creation section 17 creates a time image, a background image (background information) and/or a weather image W under the control of the reproduction control section 12a, and carries out reproduction of content such as still images, movies, text and music/sound. Display of a background image and a weather image is also carried out.

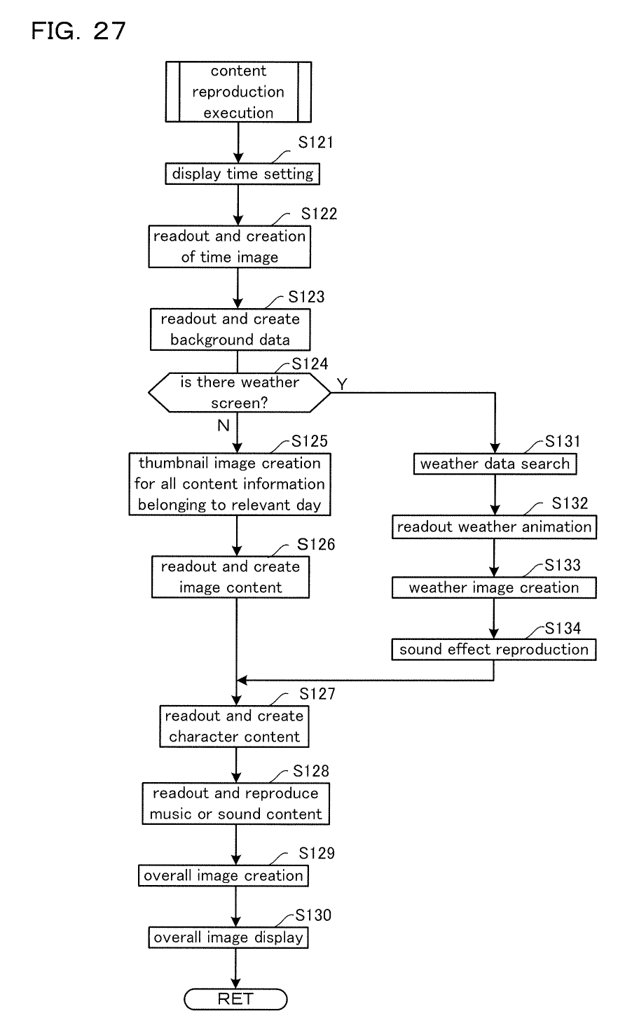

With the content reproduction preparation of step S103, content preparation is carried out for one day's worth of the relevant day, and this one day's worth of content is reproduced in order. With the example of FIG. 21, reproduction of content for the relevant month is carried out similarly for the case of the relevant day. Details will be described later using FIG. 27.

Next it is determined whether a command to terminate reproduction and display has been issued (S106). The termination command is performed by the operation section 14. If the result of determination is that a termination command has been issued, processing returns to the original processing flow. On the other hand, if there is no termination command, it is next determined whether or not there is a second date (S108).

This date is the following day in the example of FIG. 19, and for example, with the example of FIG. 19, in the event that initially this step is passed through, it is determined whether or not it is April 9th. Specifically, the display time is advanced a specified time (for example, 5 minutes) with every execution of the content reproduction execution S104, and since the next day arrives if 24 hours have elapsed with accumulation of this time advancement, it is determined whether or not the date is one day following the date up to that point. Also, with the example of FIG. 21, it is determined whether or not it is the next month.

If the result of determination in step S108 is that the second date has not been reached, processing returns to step S104 and reproduction execution of content is carried out. Specifically, by repeatedly executing steps S104 to S108, display of content and weather information is carried out for the relevant day or the relevant month.

On the other hand, if the result of determination in step S108 is that the second date has been reached, the next higher unit is switched to (S109). Specifically, with the example of FIG. 19, the next day is switched to and the time is set to 12 am, and with the example of FIG. 21 the next month is switched to. If the switching of step S109 is completed, processing returns to step S103, where reproduction preparation of content for the next day or the next month is carried out (S111).

Next, details of a sub-routine for the content reproduction preparation of step S103 will be described using FIG. 26. First, the content search section 12c searches for content of the relevant day from the storage section 15.

Specifically, image data taken using a digital camera, a video camera, or camera of a mobile phone or the like, and sound data etc. recorded using an IC recorder, has creation date information (containing taken time and date information) attached thereto and is stored in the storage region of the storage section 15. The content search section 12c searches for image data and sound data that was created on the relevant day based on the attached creation date information.

Next, the content search section 12 searches for content of the relevant day from the external database 31 (S112). Weather data (B3), weather detail data (C4), map data, blog data and news data etc. are searched for based on a URL that is set in advance. It is also possible to search for data of the relevant day using an Internet search engine.

Next, the data searched for and acquired in step S111 and step S112 is stored by the CPU 11 in a reproduction region of the storage section 15 (S113). After that, it is determined whether image content taken by that user exists among the searched images (S114). If the result of comparison is that this taken image content does exist, reproduction time and order is set for the content (S115). Specifically, the reproduction control section 12a determines reproduction time (display time controlled by the time control section 12b) based on creation time and date information that is attached to acquired image data, sound data, text data, news data etc., and sets this reproduction order.

If the result of comparison in step S114 is that there is no taken image content, a weather screen is set (S116). Specifically, based on the weather information for the relevant day procured from the external database 31, the weather image creation section 17d creates a weather image W such as in the display examples of FIG. 21 to FIG. 24. Once steps 115 and S116 are completed, the original routine is returned to.

Next, details of a sub-routine for the content reproduction execution of step S104 will be described using FIG. 27. This content reproduction execution is controlled by the reproduction control section 12a. First of all, setting of display time is carried out (S121). With the example of FIG. 19, the display time is set to start from 12 am on Apr. 8, 2007, and be for 5 minutes, for example, and the display time is advanced by 5 minutes every time this sub-routine is passed through. Next, read out and creation of a time image is carried out (S122). With this subroutine, a time image formed from a time circle image and a content information image is created based on the display time.

Next, read out and creation of background data is carried out (S123). In this step, creation of images such as a background image B2 and a weather image B3, and creation of music and sound such as background music, are carried out, and following that it is determined whether or not there is a weather screen (S124). Specifically, in step S114, if there is no taken image content a weather screen is set in step S116, and it is determined whether or not this weather screen has been set.

If the result of determination in step S124 is that the weather screen has not been set, thumbnail images for all content information belonging to the relevant day are created (S125). Next, readout and creation of taken image content is carried out (S126). Here, creation of content used for reproduction is carried out based on image data, sound data, and text data etc. stored in the storage section 15.

On the other hand, if the result of determination in step S124 is that there is a weather screen, weather data is searched for (S131). In the event that information search for the relevant day from the external database 31 in step S113 is skipped, this here involves accessing the external database 31 and procuring weather data for the relevant day. Next, a weather animation is read out (S132). Specifically, data for carrying out an animated display as is shown in FIG. 21 to FIG. 24 is read out.

Next weather information creation is carried out (S133). Here, the weather image creation section 17d creates a weather image using the weather data and weather animation data for the relevant day, and display that weather image. Next, sound effect reproduction is carried out (S134). Specifically, data for a sound effect corresponding to the weather is read out from the storage section 15 and reproduced by the sound reproducing section 19, and the sound effect is reproduced using the speaker section 20.

If step S126 or step S134 are completed, readout and creation of character data is carried out next (S127). As the character content here, there is, for example, weather detail information C4 such as is shown in FIG. 24. Next, reading and reproduction of music or sound content is carried out (S128). Here, read out and reproduction of music or sound such as created background music, and data such as sound C5 is carried out in step S123, and output from the speaker section 20. It is also possible to reproduce music as BGM (background music) for the weather image.

Next creation of an overall image is carried out (S129). The background image, time image, content and/or weather image that were created based on the display time set in step S121 are combined to give an overall image. Next, display of this created overall image is carried out (S130). If display of the overall image is completed, the original routine is returned to.

In this way, with the second embodiment of the present invention, when reproducing contents in line with creation time and date, such as the when date content was taken, in the event that content such as taken images to be reproduced does not exist, a weather image is created and this weather image is displayed. Therefore, even in cases such as where the user's own content is not reproduced over a long period of time, the user is not bored. Since there is not a background image but a weather image, it is possible to put changes on the screen, and it is possible to give an atmosphere for the relevant time.

Also, within this embodiment, what is displayed in the event that there is no content is a weather image, which means that in a slideshow etc. it is helpful in evoking the relevant time. Also, when displaying the weather image, since animated display is carried out it is possible to bring the scene to life. Further, since sound effects associated with the weather image are reproduced, it is possible to further increase the realism.

Still further, within this embodiment weather information is procured from the external database 31 by means of the Internet, which means that there is no load on the reproduction device, and there is the advantage of high information precision. Also, the weather information does not have to be only past weather information, and it can be forecasted weather information for the future.

With the second embodiment of the present invention, a weather image is displayed in a period when there are no taken images, but this is not limiting, and it is also possible, for example, to be an image that has been created based on information corresponding to the screen time (time on the screen controlled by the time control section 12b, such as display time), such as news text information and stock market information, or a movie relayed during news or sports. These images also, similarly to the weather image, can be procured by searching the external database 31.

Also with the second embodiment of the second invention, when displaying the time, especially when the time and date transitions are not important, it is also possible to omit the time image. As the determination as to whether or not there is a period in which content such as image to be reproduced does not exist, within this embodiment, with the example of FIG. 19 units of one day are used, while in the example of FIG. 21 units of one month are used, but this is not limiting, and it is also possible to appropriately change the units used to units of half a day, units of a week, or units of half a month. In this case, it is preferable to appropriately change the display of the time circle.

Further, with the second embodiment of the present invention, in step S114 a weather screen is set in the case where there is no taken image content. However, it is also possible to set the weather image only for cases where, besides taken image content, the result of searching in step S111 and S112 is that there is no user designated content (for example, sound data or weather detail data from the web).

It is also possible, in the first and second embodiments of the present invention, for some or all of the processing by the CPU 11 to be implemented as hardware. Conversely, it is also possible for hardware of the image creation sections to be realized as software. Specific construction is a matter of design. As a storage medium for storing programs, flash memory has been used in these embodiments, but this is not limiting and it is also possible, for example, to use optical storage media such as CD-ROM or DVD, magneto-optical storage media such as MD, tape media, or semiconductor memory such as IC card.

Also, with the first and second embodiments of the present invention a circle display has been used when displaying the time, but this is not limiting, and it is also possible, for example, to use straight lines or curved lines, as long as it is possible to represent the passage of time. Also, background image and background music have been changed according to display time, but it is possible to keep it fixed, without changing. Further, the reproduced content is limited, although it is not absolutely necessary to connect to an external database using the Internet etc.

Further, in the description of the first and second embodiments of the present invention, an example adopting a personal computer has been given, but this is not limiting and it is also possible, for example, to have a television that is capable of connecting to the internet. In any event, it is possible to adopt the present invention to devices that are capable of storing and reproducing multi-content.

Further, the present invention is not limited to only the above described first and second embodiments, and structural elements may be modified in actual implementation within the scope of the gist of the embodiments. It is also possible form various inventions by suitably combining the plurality structural elements disclosed in the above describe embodiments. For example, it is possible to omit some of the structural elements shown in the embodiments. It is also possible to suitably combine structural elements from different embodiments.

What is claimed is:

1. A reproducing unit, comprising:
a time control section for controlling time in order to reproduce content having time and date information in an order according to that time and date information;
a content search section for searching for content having time and date information corresponding to a time defined by the time control section from a plurality of categories of content;
a storage section for storing a plurality of the searched contents of differing categories;
a time image creation section for creating a time image, where the time image includes time information representing a specified range of time, controlled by the time control section, by a specified length, and content information arranged at a position of the time information corresponding to the time information, for representing that content of time and data information corresponding to that time and date information exists; and
a reproduction control section for performing control so that together reproduction of the time image, the stored content of different categories is reproduced at a timing corresponding to the category of the content, on the basis of time controlled by the time control section.

2. The reproducing unit of claim 1, wherein:
a communication section for carrying out data communication with an external data base via the Internet is provided, and
the content search section searches for the content using the external database.

3. The reproducing unit of claim 1, wherein:
images are contained in the categories of the content, and
the content search section searches for image content based on the time the images were taken.

4. The reproducing unit of claim 3, wherein:
a background image creation section is provided for creating a background image constituting a background for the time image, and
for the time image and the image content the reproduction control section reproduces that image, and in addition also reproduces a background image.

5. The reproducing unit of claim 4, wherein:
the background image creation section creates a map image corresponding to position information contained in the search content, as a background image.

6. The reproducing unit of claim 1, wherein:
a background image creation section is provided for creating a background image constituting a background for the time image, and
the content search section searches for weather information corresponding to time controlled by the time control section from the external database, and
the background image creation section creates a background image using the weather searched weather information.

7. The reproducing unit of claim 1, wherein:
the content search section searches for news information corresponding to time controlled by the time control section.

8. The reproducing unit of claim 1, wherein:
the time image creation section creates a plurality of time axes of circular shape having different time units, as the time information.

9. The reproducing unit of claim 1, wherein:
the content search section searches for content from at least three categories of image, sound and text.

10. A reproducing method, for reproducing content having time and date information in an order according to that time and date information, comprising the steps of;
searching for content having time and date information corresponding to a defined time, from within content of a plurality of categories;
storing plurality of the searched contents of differing categories;
creating a time image, including content information arranged at a position of the time information corresponding to the time information, for representing time information representing a specified range of time by a specified length, and representing that content of time and data information corresponding to that time and date information exists; and
performing control so that the stored content of different categories is reproduced at a timing corresponding to the category of the content, on the basis of controlled time.

11. A computer readable storage medium, storing a program for reproducing content having time and date information in an order according to that time and date information, wherein:
content having time and date information corresponding to a defined time, is searched for from within content of a plurality of categories;
a plurality of the searched contents of differing categories are stored;
a time image, including content information arranged at a position of the time information corresponding to the time information, for representing time information representing a specified range of time by a specified length, and representing that content of time and data information corresponding to that time and date information exists, is created; and
control is performed so that the stored content of different categories is reproduced at a timing corresponding to the category of the content, on the basis of controlled time.

12. A computer readable storage storing the program of claim 11, wherein
when searching for the content from within content of a plurality of the categories,
data communication is carried out with an external data base via the Internet, and
the content is searched for using the external database.

13. A computer readable storage storing the program of claim 11, wherein
images are contained in the categories for the content, and
when searching for the content, for image content search is carried out based on the time the images were taken.

14. A computer readable storage storing the program of claim 13, wherein
a background image constituting a background for the time image is created, and
for the time image and the image content, that image is reproduced, and a background image is also reproduced.

15. A computer readable storage storing the program of claim 14, wherein
when creating the background image, a map image corresponding to position information contained in the search content is created as a background image.

16. A computer readable storage storing the program of claim 12, wherein
a background image constituting a background for the time image is created,
weather information corresponding to controlled time is searched from the external database, and
a background image is created using the searched weather information.

17. A computer readable storage storing the program of claim 12, wherein
when searching for the content, news information corresponding to time controlled by the time control section is searched for.

18. A computer readable storage storing the program of claim 11, wherein
when creating the time image, a plurality of time axes of circular shape having different time units are created as the time image.

19. A computer readable storage storing the program of claim 11, wherein
when searching for the content, content is searched for from at least three categories of image, sound and text.

20. A reproducing unit, comprising:
a time control section for controlling time on a screen as screen time, in order to reproduce content containing images on the screen;
a time image creation section for creating a time image representing the screen time;
a content image creation section for creating a corresponding content image from the content containing image;
a weather image creation section for creating an image related to weather information corresponding to the screen time; and
a reproduction control section for controlling reproduction of the created time image, and also performing control to reproduce the content image at a time, in screen time, that corresponds to the date and time the image was taken, wherein
the reproduction control section performs control to reproduce an image relating to the weather information, instead of the content image, when no content images are displayed for a fixed period.

21. The reproducing unit of claim 20, wherein:
a content search section is provided for procuring the weather information from among content stored in an external database, and
the weather image creation section creates an image relating to the weather information based on the procured weather information.

22. The reproducing unit of claim 20, wherein:
a sound reproducing section is provided for reproducing sound effects, and
the reproduction control section reproduces an image relating to the weather information and a sound effect corresponding to the reproduced image from the sound reproducing section.

23. The reproducing unit of claim 20, wherein:
the weather image creation section creates an animated image representing weather as the image relating to the weather information.

24. A reproducing unit, comprising:
a time control section for controlling time on a screen as screen time, in order to reproduce content containing images on the screen;
a content image creation section for creating a corresponding content image from the content containing images;
a corresponding information image creation section for creating an image related to information corresponding to the screen time; and
a reproduction control section for performing control to reproduce the content image at a time it was taken, in screen time, according to the time and date the content image was taken, and also performing control to reproduce an image relating to the image related to information corresponding to the screen time instead of the content image when no content image is displayed for a fixed period.

25. The reproducing unit of claim 24, wherein:
a time image creation section is provided for creating a time image representing the screen time, and the reproduction control section performs display of the time image.

26. The reproducing unit of claim 24, wherein:
a communication section is provided for connecting to an external database, and information corresponding to the screen time is acquired using the external database.

27. The reproducing unit of claim 24, wherein:
the information corresponding to the screen time contains at least one of information relating to weather, news and sports.

28. The reproducing unit of claim 24, wherein:
the time control section performs time control in day units or month units.

29. A reproduction method for reproducing content including an image while controlling time on a screen as screen time, wherein
a time image representing the screen time is created;
a corresponding content image is created from the image content;
an image related to weather information corresponding to the screen time is created; and
control is performed to reproduce the created time image, and control is also performed to reproduce the content image at a time, in screen time, according to the time and date that image was taken, and at that time control is performed to reproduce an image relating to the weather information, instead of the content image, when no content image is displayed for a fixed period.

30. A reproduction method for reproducing content based on screen time, which is a time on a screen, in order to reproduce content including an image on the screen, wherein
a corresponding content image corresponding is created from the image content, or an image relating to information corresponding to the screen time is created,
it is determined whether or not a period when content images are not displayed is a fixed period,
when the result of determination is that content images are displayed during the fixed period, the content time image is reproduced at a time, in screen time, according to the time and data that image was taken, while when the result of determination is that content images are not displayed for the fixed period, an image relating to the corresponding information, instead of the content image, is reproduced.

31. A program for reproducing content including an image while controlling time on a screen as screen time, wherein
a time image representing the screen time is created;
a corresponding content image is created from the image content;
an image related to weather information corresponding to the screen time is created; and
control is performed to reproduce the created time image, and control is also performed to reproduce the content image at a time, in screen time, according to the time and date that image was taken, and at that time control is performed to reproduce an image relating to the weather information, instead of the content image, when no content image is displayed for a fixed period.

32. A computer readable storage medium storing a program for reproducing content based on screen time, which is a time on a screen, in order to reproduce content including an image on the screen, wherein
a corresponding content image is created from the image content, or an image relating to information corresponding to the screen time is created,
it is determined whether or not a period when content images are not displayed is a fixed period, and
when the result of determination is that content images are displayed during the fixed period, the content time image is reproduced at a time, in screen time, according to the time and data that image was taken, while when the result of determination is that content images are not displayed for the fixed period, an image relating to the corresponding information, instead of the content image, is reproduced.

33. A computer readable storage storing the program of claim 32, wherein
a time image representing the screen time is created, and the content image and an image relating to information corresponding to the screen time are reproduced together.

34. A computer readable storage storing the program of claim 32, wherein
an external database is connected to, and information corresponding to the screen time is acquired from the external database.

35. A computer readable storage storing the program of claim 32, wherein
information corresponding to the screen time contains at least one of information relating to weather, news and sports.

36. A computer readable storage storing the program of claim 32, wherein
control of the screen time is carried out in day units or month units.

37. A computer readable storage medium storing a program for reproducing content based on screen time, which is a time on a screen, wherein
a content image for reproduction is created from the user created data, or content is created based on information corresponding to the screen time,
it is determined whether or not a period when content for reproduction is not displayed is a fixed period, and
when the result of determination is that content for reproduction is displayed during the fixed period, the content for reproduction is reproduced at a time, in screen time, according to the time and data that content was created, while when the result of determination is that content for reproduction is not displayed for the fixed period, content is created based on an information relating to the screen time, instead of the content for reproduction, and the content is reproduced.
